(19) United States
(12) Patent Application Publication
(10) Pub. No.: US 2017/0315704 A1
(43) Pub. Date: Nov. 2, 2017

(54) APPLICATION USER INTERFACES WITH SCROLLABLE COLOR PALETTES

(71) Applicant: Microsoft Technology Licensing, LLC, Redmond, WA (US)

(72) Inventors: Han-Yi Shaw, Redmond, WA (US); Brian Thomas Kelley, Seattle, WA (US)

(21) Appl. No.: 15/144,071

(22) Filed: May 2, 2016

(51) Int. Cl. G06F 3/0484; G06T 11/00; G06F 3/0482

(52) U.S. Cl. CPC G06F 3/04842; G06F 3/0482; G06T 11/001

(57) ABSTRACT

Systems, methods, and software are disclosed herein for enhancing color palettes in user interfaces. In an implementation, a color palette in a user interface includes a primary color palette and a secondary color palette, both rendered only partially in the color palette, thereby occupying less screen space than otherwise. The primary and secondary color palettes are rotatable such that a selection of a control form one or the other causes the primary or secondary palette to rotate the selected control to a center position in the color palette.

### TECHNICAL BACKGROUND

Many software applications provide drawing tools that allow users to create handwritten notes, annotate existing notes, sketch images, or otherwise draw in a user interface to an application. Drawings tools may be found in a variety of applications, including note taking applications, productivity applications, and graphic design applications, and may be especially useful in the context of touch-based surfaces.

Drawing tools are usually accessed via a “draw” tab in a feature tool bar. For example, the draw tab may be one among a file tab, a home tab, an insert tab, and so on. Examples of drawing tools include various inking implements for inking in the user interface, an eraser for erasing ink, thickness tools for adjusting the thickness of an implement, and a color palette for managing the color of the inking content.

Color palettes are often rendered as drop-down menus or floating palettes in the user interface. The palettes typically include a set of color controls that correspond to the color hues and shades (brightness and saturation) that are available in the application. Selecting a given color control in a palette configures an active inking implement to draw in the color hue and shade corresponding to the selected color control.

Unfortunately, the large number of different colors and color shades can lead to relatively large color palettes. From a technical perspective, a typical color palette may include two or three dozen different controls from which to select a color in a particular shade, such as dark blue, light blue, and sky blue. Such a large palette may occupy a relatively large and valuable amount of screen space, especially when presented in the context of smaller form-factor devices, such as tablets, phones, and other mobile devices.

### OVERVIEW

Enhanced color palettes and other technical advances are disclosed herein that improve the functioning of and interaction with software applications. In an implementation, a color palette in a user interface includes a primary color palette and a secondary color palette, both rendered only partially in the color palette, thereby occupying less screen space than otherwise. The primary and secondary color palettes are rotatable such that a selection of a control form one or the other causes the primary or secondary palette to rotate the selected control to a center position in the color palette.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a color palette in a user interface to an application in an implementation of enhanced color palette technology.

FIG. 2 illustrates a process employed by an application in an implementation.

FIG. 3 illustrates an operational scenario in an implementation.

FIG. 4 illustrates an operational scenario in an implementation.

FIG. 5 illustrates an operational scenario in an implementation.

FIG. 6 illustrates a software environment in an implementation.

FIG. 7 illustrates a computing system suitable for implementing the enhanced color palette technology disclosed herein, including any of the applications, architectures, elements, processes, and operational scenarios and sequences illustrated in the Figures and discussed below in the Technical Disclosure.

### TECHNICAL DISCLOSURE

An enhanced color palette is disclosed herein that may be surfaced in a user interface to an application. The color palette may include a primary color palette for selecting a color, and a secondary palette for selecting the another characteristic of the color (e.g. brightness and saturation, or the shade of the color). In some implementations, the color palette may be rendered as a semi-circle in such a way that it is tucked under a feature menu in the user interface, such as the Office Ribbon in Microsoft® Office properties. The primary and secondary color palettes may be scrollable such that not all of the controls in a palette are visual at a given time. This may provide the technical effect of conserving screen space in the user interface on smaller form factor devices such as the iPad®.

In some scenarios, the primary color palette is implemented as an outer ring in the color wheel, while the secondary color palette is implemented as an inner ring. The outer ring may set the hue for a drawing tool, while the inner ring sets the brightness and saturation. The outer ring may scroll by rotation that is invoked by a user selecting a desired hue or by flicking the color wheel to rotate to the desired hue. They flick may give the visual impression of having inertia so that the outer ring slows down as it approaches the selected hue. The selected hue may remain highlighted and center-aligned at the bottom of the color wheel to set it apart visually. The hues in the outer ring may be presented as circles (with the selected hue having a ring around it) to set the apart from the controls in the inner ring, which may normally take on a trapezoidal shape.

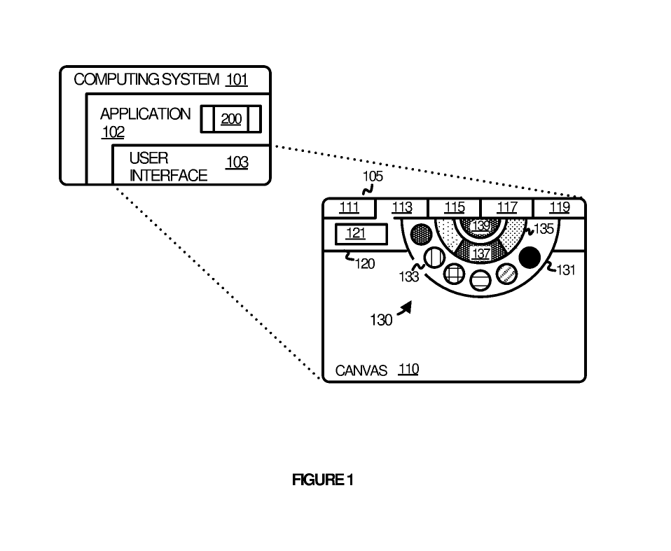

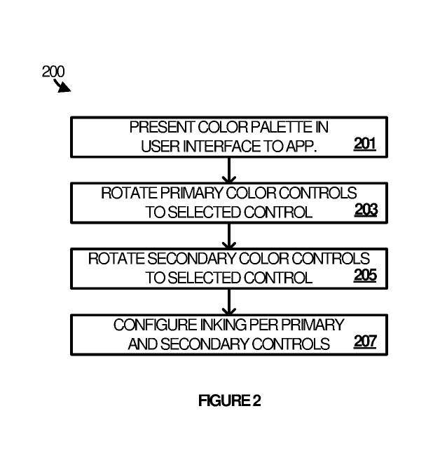

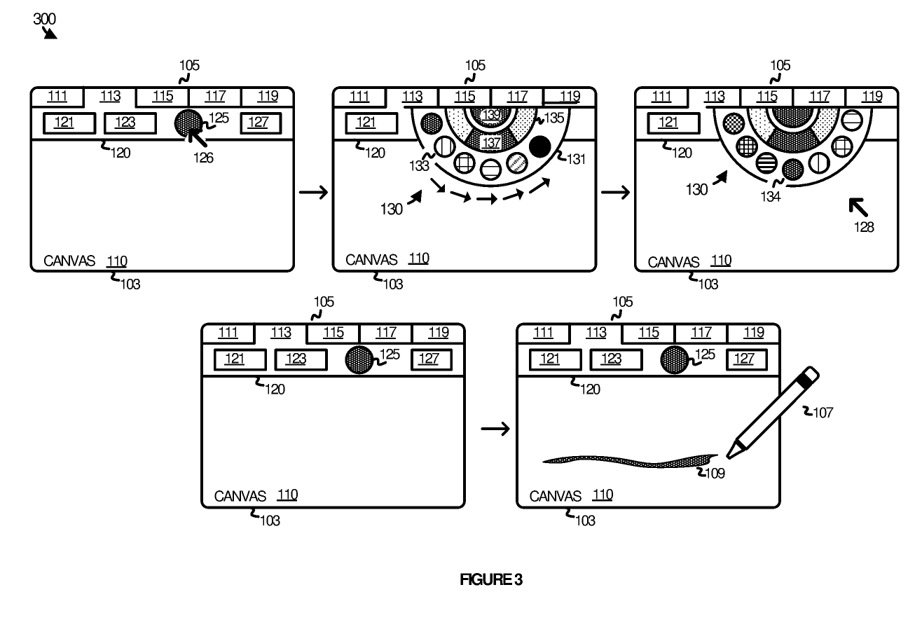

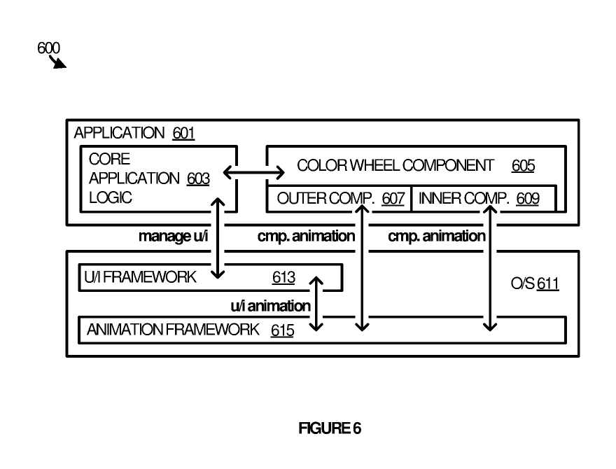

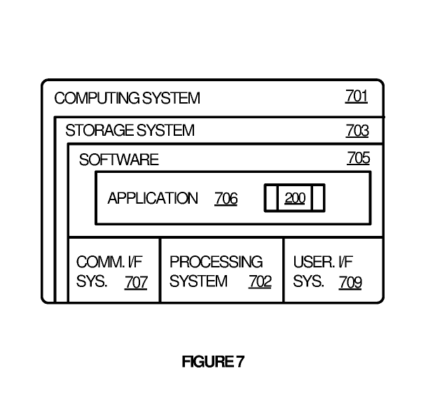

Referring to the drawings, FIG. 1 illustrates a computing system and a user interface rendered by an application on the computing system. The user interface includes an enhanced color palette as contemplated herein. FIG. 2 illustrates a process that may be employed by the application to present the color palette. FIGS. 3-5 illustrate various operational scenarios that may occur in the user interface. The operational scenarios may be stand-alone scenarios or may be considered to occur in series in some implementations. FIG. 6 illustrates a software environment to support an enhanced color palette, while FIG. 7 illustrates a representative computing system for executing said applications.

Turning to FIG. 1, color palette 103 is rendered by computing system 101 in a user interface 103 to an application 102. The application may be a natively installed application, a browser-based application that runs in the context of a web browser, or any other type of application that may utilize a color palette in its user interface. Specific examples include, but are not limited to, note-taking applications (e.g. OneNote® and Evernote), office productivity applications (Microsoft® Office applications and Google® Docs), and graphical design applications.

Computing system 101 is representative of any device suitable for running an application and presenting a user interface with a color palette included therein. Examples include, but are not limited to, tablet computers, phablet computers, mobile phones, laptop computers, and desktop computers, as well as any other suitable physical or virtual device, including combinations and variations thereof, of which computing system 701 illustrated in FIG. 7 is representative.

Application 102 employs process 200 in the context of surfacing color palette 130 in user interface 103. The following discussion makes parenthetical reference to the steps illustrated in FIG. 2 with respect to process 200.

In operation, application 102 presents a color palette in user interface 105 that includes primary color controls and secondary color controls (step 201). When the color palette is first opened or when a primary color control is selected, the primary color controls are rotated to bring the selected control into a center position in the palette (step 203). Similarly, when a secondary color control is selected, the secondary color controls are rotated to bring the selected control in a center position in the palette (step 205). An active drawing tool is thus configured for inking per the selected primary and secondary controls (step 207).

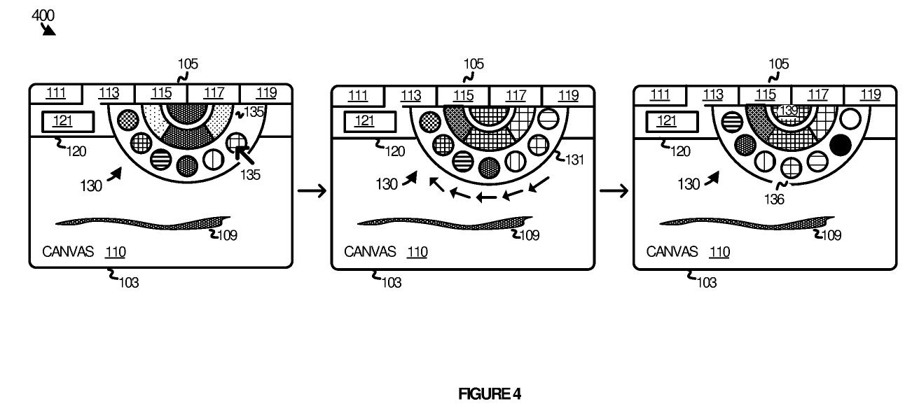

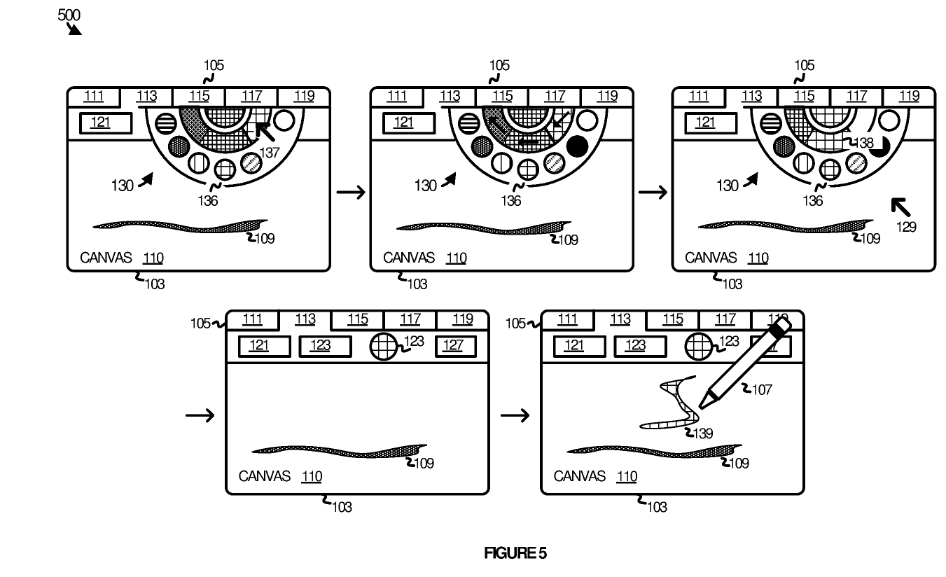

FIGS. 3-5 illustrate various operational scenarios to further demonstrate various aspects of enhanced color palette technology with respect to user interface 103. In particular, FIG. 3 illustrates an operational scenario 300 that relates to what occurs when an enhanced color palette as initially opened in a user interface to an application. FIG. 4 illustrates an operational scenario 400 that relates to what occurs when a user desires to select a new color from the color palette. In FIG. 5, operational scenario 500 relates to what occurs when the user selects a new shade from the color palette.

Referring to FIG. 3, operational scenario 300 involves user interface 103 to application 102, such as a note taking application, a word processing application, and the like. User interface 103 includes a feature menu 105 through which various tool bars may be accessed. Feature menu 105 includes tabs that correspond to the tool bars, including tab 111, tab 113, tab 115, tab 117, and tab 119.

Examples of the tabs in feature menu 105 include a home tab, an insert tab, a review tab, and a draw tab. Other tabs in addition to or in place of those illustrated in feature menu 105 are possible and may be considered within the scope of the disclosure. Tab 113 is representative of the drawing tab.

In operational scenario 300, selecting tab 113 brings tool bar 120 into view in which various drawing tools are available. The drawing tools may be invoked by touching, clicking on, or otherwise selecting one of the corresponding menu controls in tool bar 120, represented by menu element 121, menu element 123, menu element 125, and menu element 127. Menu elements 121, 123, 125, and 127 may correspond to and lunch various drawing tools, such as a drawing implement (pen, pencil, etc.), a line adjustment tool, an eraser, or other such tools.

Menu element 125 corresponds in particular to color palette 130, referred to above as a “color wheel” due to its circular appearance. Color palette 130 drops down from underneath feature menu 105 when menu element 125 is selected by user input 126 (e.g. a touch, mouse click, or spoken command) Menu element 125 is configured in the active color and shade previously selected from color palette 130. The appearance of color palette 130 gives the visual impression that it is “tucked under” feature menu 105. Color palette 130 may optionally drop down from underneath tool bar 120. While shown as a semi-circle, it may be appreciated that color palette 130 could be implemented in a variety of shapes and layouts, including as a square or rectangular-shaped palette, an oval, or the like.

Color palette 130 includes a primary palette 131 and a secondary palette 135. Primary palette 131 includes various primary color controls for selecting the color of a drawing tool, represented by primary color control 133. Secondary palette 135 includes various secondary color controls for selecting the shade of a selected color, of which secondary color control 137 is representative. Lastly, graphic 139 is configured in the active color and shade selected via the primary and secondary color palettes. Thus, the color and shade of graphic 139 matches that of menu element 125 when color palette 130 first drops down and expands into view.

When color palette 130 drops down from underneath feature menu 105, primary color palette 133 rotates either clockwise or counter-clockwise to bring the most recently selected primary color control into a center position. The most recent control is represented by primary color control 134 in this example. Secondary color palette 135 may be rendered with the selected secondary control already in a center position. Optionally, secondary color palette 135 may also be rotated clockwise or counter clockwise to bring the selected secondary control into the center position.

Thus, once color palette 130 has been opened fully, the active primary and secondary controls are aligned with respect to each other and with respect to graphic 139. The user may proceed to provide another user input 128 to select some element other than color palette 130 and its components in order to begin inking in the selected color and shade. Color palette 130 disappears or otherwise recedes into feature menu 105 and the user may draw content 109 on canvas 110 with a digital pen 107, by touch, or in some other manner.

In FIG. 4, operational scenario 400 begins with color palette 130 open and content 109 having been drawn on canvas 110. It may be presumed that color palette 130 was opened in response to a user selection of menu element 125 in user interface 103. User input 135 is provided to select a different primary color control, thereby causing primary color palette 131 to rotate clockwise until primary color control 136 is in a center position. The rotation brings other primary color controls for other color into view, that were previously hidden from view. In addition, some of the primary color controls that were in view are rotated out of view. The controls in secondary color palette 135 are replaced by secondary controls associated with the newly selected color via primary color control 136.

At this point, the user could proceed to close color palette 130 and draw in the active ink color and shade. However, the user may desire a different shade of the selected color than that represented in graphic 139. Accordingly, in operational scenario 500 illustrated in FIG. 5, a user input 137 may select a different shade of the color by selecting secondary color control 138. Secondary color palette 135 rotates in response to the selection, to bring secondary color control 138 to a center position in color palette 130. Graphic 139 changes to match the selected color and shade combination. The user may proceed to provide another user input 129 to select some element other than color palette 130 and its components in order to begin inking in the selected color and shade. Color palette 130 disappears or otherwise recedes into feature menu 105 and the user may draw content 139 on canvas 110 with a digital pen 107, by touch, or in some other manner.

FIG. 6 illustrates a software environment 600 that may be employed by a suitable computing device to support enhanced color palettes as disclosed herein. Software environment 600 includes application 601 and operating system 611. Application 601 includes core application logic 603 and color wheel component 605. Color wheel component 605 includes outer component 607 and inner component 609. Operating system 611 includes user interface framework 613 and animation framework 615.

Application 601 is representative of a note taking application, office productivity application, graphical design application, or any other software product that may utilize a color palette in its user interface. Core application logic 603 is representative of the main program code that provides the features and functionality of application 601. Core application logic 603 communicates with user interface framework 613 in operating system 611 to manage aspects of the user experience, such as receiving user input, managing application views, and otherwise driving a user interface.

User interface framework 613 is representative of code in operating system 611 that supports user interface features and functionality. Animation framework 615 is representative of additional code that may facilitate certain animation functionality for user interface framework 613. The sub-components of color wheel component 605 may also communicate directly with animation framework 615.

Outer component 607 and inner component 609 are each representative of code that supports animation of a color wheel in a user interface to application 601. The outer component 607 is invoked by color wheel component 605 when user input is communicated to core application logic 603 that relates to an outer wheel in the color wheel. The inner component 609 is invoked by color wheel component 605 when user input is communicated to core application logic 603 that relates to an inner wheel in the color wheel.

When outer wheel 607 is invoked, it interfaces with animation framework 615 to carry out a specific animation of the color wheel. Outer component 607 may pass starting points, end points, and other parameters related to how the outer wheel should be rotated. For instance, when a user selects a new color in the outer color wheel, core application logic 603 calls color wheel component 605. Color wheel component 605 invokes outer component 607, which then calls into animation framework 615 with the parameters or related parameters for the animation. When the animation is complete, outer component 607 returns to color wheel component 605, which then returns control to core application logic 603.

Likewise, when inner component 609 is invoked, it interfaces with animation framework 615 to carry out an animation related to the inner wheel in the color wheel. Inner component 609 may pass starting points, end points, and other parameters related to how the inner wheel should be rotated. When the animation is complete, inner component 609 returns to color wheel component 605, and then in turn to core application logic 603.

FIG. 7 illustrates computing system 701, which is representative of any system or collection of systems in which the various applications, services, scenarios, and processes disclosed herein may be implemented. Examples of computing system 701 include, but are not limited to, smart phones, laptop computers, tablet computers, desktop computers, hybrid computers, gaming machines, virtual reality devices, smart televisions, smart watches and other wearable devices, as well as any variation or combination thereof. Other examples, may include server computers, rack servers, web servers, cloud computing platforms, and data center equipment, as well as any other type of physical or virtual server machine, container, and any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes process 706 which is representative of the processes discussed with respect to the preceding FIGS. 1-6, including process 200. When executed by processing system 702 to enhance color palettes, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. For example, software 705 may include program instructions for implementing an enhanced color palette.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtual machine software, or other application software, in addition to or that include process 706. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to enhance color palette operations. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here.

User interface system 709 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTMLS, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

### Example 1

A computing apparatus comprising: one or more computer readable storage media; a processing system operatively coupled to the one or more computer readable storage media; and an application stored on the one or more computer readable storage media and comprising program instructions that, when executed by the processing system, direct the processing system to at least: present a color palette in a user interface to the application, the color palette comprising a primary color palette and a secondary color palette; in response to a selection of a primary color control from a set of primary color controls in the primary color palette, rotate the set of primary color controls in the primary color palette until the primary color control occupies a center position in the primary color palette; and in response to a selection of a secondary color control from a set of secondary color controls in the secondary color palette, rotate the set of secondary primary controls in the secondary color palette until the secondary color control occupies a center position in the secondary color palette.

### Example 2

The computing apparatus of Example 1 wherein the program instructions further instruct the processing system to rotate the primary color palette to a previously selected one of the set of primary color controls upon opening the color palette in the user interface.

### Example 3

The computing apparatus of Examples 1-2 wherein each one of the set of primary color controls corresponds to a different one of a set of colors.

### Example 4

The computing apparatus of Examples 1-3 wherein each one of the set of secondary color controls corresponds to a shade of a color in the set of colors that corresponds to the primary color control in the center position in the primary color palette.

### Example 5

The computing apparatus of Examples 1-4 wherein the color palette comprises a semi-circle shape.

### Example 6

The computing apparatus of Examples 1-5 wherein the color palette further comprises the set of primary controls arranged in an outer semi-circle within the semi-circle shape.

### Example 7

The computing apparatus of Examples 1-6 wherein the color palette further comprises the set of secondary controls arranged in an inner semi-circle within the semi-circle shape.

### Example 8

The computing apparatus of Examples 1-7 wherein the color palette further comprises a half-circle positioned centrally in the semi-circle shape and having the color and the shade.

### Example 9

A method of operating an online application service, the method comprising: presenting a color palette in a user interface to an online application, the color palette comprising a primary color palette and a secondary color palette; in response to a selection of a primary color control from a set of primary color controls in the primary color palette, rotating the set of primary color controls in the primary color palette until the primary color control occupies a center position in the primary color palette; and in response to a selection of a secondary color control from a set of secondary color controls in the secondary color palette, rotating the set of secondary primary controls in the secondary color palette until the secondary color control occupies a center position in the secondary color palette.

### Example 10

The method of claim 9 further comprising rotating the primary color palette to a previously selected one of the set of primary color controls upon opening the color palette in the user interface.

### Example 11

The method of Examples 9-10 wherein each one of the set of primary color controls corresponds to a different one of a set of colors.

### Example 12

The method of Examples 9-11 wherein each one of the set of secondary color controls corresponds to a shade of a color in the set of colors that corresponds to the primary color control in the center position in the primary color palette.

### Example 13

The method of Examples 9-12 wherein the color palette comprises a semi-circle shape.

### Example 14

The method of Examples 9-13 wherein the color palette further comprises the set of primary controls arranged in an outer semi-circle within the semi-circle shape.

### Example 15

The method of Examples 9-14 wherein the color palette further comprises the set of secondary controls arranged in an inner semi-circle within the semi-circle shape.

### Example 16

The method of Examples 9-16 wherein the color palette further comprises a half-circle positioned centrally in the semi-circle shape and having the color and the shade.

### Example 17

One or more computer readable storage media having program instructions stored thereon for rendering a color palette in a user interface to an application, wherein the program instructions, when executed by a processing system, direct the processing system to at least: present a primary color palette and a secondary color palette in the color palette; in response to a selection of a primary color control from a set of primary color controls in the primary color palette, rotate the set of primary color controls in the primary color palette until the primary color control occupies a main position in the primary color palette; and in response to a selection of a secondary color control from a set of secondary color controls in the secondary color palette, rotate the set of secondary primary controls in the secondary color palette counter to a rotational direction of the set of primary color controls until the secondary color control occupies a main position in the secondary color palette.

### Example 18

The one or more computer readable storage media of Example 17 wherein each one of the set of primary color controls corresponds to a different one of a set of colors.

### Example 19

The one or more computer readable storage media of Examples 17-18 wherein each one of the set of secondary color controls corresponds to a shade of a color in the set of colors that corresponds to the primary color control in the center position in the primary color palette.

### Example 20

The one or more computer readable storage media of Examples 17-19 wherein the color palette comprises a semi-circle shape, wherein the color palette further comprises the set of primary controls arranged in an outer semi-circle within the semi-circle shape, and wherein the color palette further comprises the set of secondary controls arranged in an inner semi-circle within the semi-circle shape.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled to the one or more computer readable storage media; and
an application stored on the one or more computer readable storage media and comprising program instructions that, when executed by the processing system, direct the processing system to at least:
present a color palette in a user interface to the application, the color palette comprising a primary color palette and a secondary color palette;
in response to a selection of a primary color control from a set of primary color controls in the primary color palette, rotate the set of primary color controls in the primary color palette until the primary color control occupies a center position in the primary color palette; and
in response to a selection of a secondary color control from a set of secondary color controls in the secondary color palette, rotate the set of secondary primary controls in the secondary color palette until the secondary color control occupies a center position in the secondary color palette.

2. The computing apparatus of claim 1 wherein the program instructions further instruct the processing system to rotate the primary color palette to a previously selected one of the set of primary color controls upon opening the color palette in the user interface.

3. The computing apparatus of claim 1 wherein each one of the set of primary color controls corresponds to a different one of a set of color hues.

4. The computing apparatus of claim 3 wherein each one of the set of secondary color controls corresponds to a shade of a color hue in the set of color hues that corresponds to the primary color control in the center position in the primary color palette.

5. The computing apparatus of claim 4 wherein the color palette comprises a semi-circle shape.

6. The computing apparatus of claim 5 wherein the color palette further comprises the set of primary controls arranged in an outer semi-circle within the semi-circle shape.

7. The computing apparatus of claim 6 wherein the color palette further comprises the set of secondary controls arranged in an inner semi-circle within the semi-circle shape.

8. The computing apparatus of claim 7 wherein the color palette further comprises a half-circle positioned centrally in the semi-circle shape and having the color hue and the shade.

9. A method of operating an online application service, the method comprising:
presenting a color palette in a user interface to an online application, the color palette comprising a primary color palette and a secondary color palette;
in response to a selection of a primary color control from a set of primary color controls in the primary color palette, rotating the set of primary color controls in the primary color palette until the primary color control occupies a center position in the primary color palette; and
in response to a selection of a secondary color control from a set of secondary color controls in the secondary color palette, rotating the set of secondary primary controls in the secondary color palette until the secondary color control occupies a center position in the secondary color palette.

10. The method of claim 9 further comprising rotating the primary color palette to a previously selected one of the set of primary color controls upon opening the color palette in the user interface.

11. The method of claim 9 wherein each one of the set of primary color controls corresponds to a different one of a set of color hues.

12. The method of claim 11 wherein each one of the set of secondary color controls corresponds to a shade of a color hue in the set of color hues that corresponds to the primary color control in the center position in the primary color palette.

13. The method of claim 12 wherein the color palette comprises a semi-circle shape.

14. The method of claim 13 wherein the color palette further comprises the set of primary controls arranged in an outer semi-circle within the semi-circle shape.

15. The method of claim 14 wherein the color palette further comprises the set of secondary controls arranged in an inner semi-circle within the semi-circle shape.

16. The method of claim 15 wherein the color palette further comprises a half-circle positioned centrally in the semi-circle shape and having the color hue the shade.

17. One or more computer readable storage media having program instructions stored thereon for rendering a color palette in a user interface to an application, wherein the program instructions, when executed by a processing system, direct the processing system to at least:
present a primary color palette and a secondary color palette in the color palette;
in response to a selection of a primary color control from a set of primary color controls in the primary color palette, rotate the set of primary color controls in the primary color palette until the primary color control occupies a main position in the primary color palette; and
in response to a selection of a secondary color control from a set of secondary color controls in the secondary color palette, rotate the set of secondary primary controls in the secondary color palette counter to a rotational direction of the set of primary color controls until the secondary color control occupies a main position in the secondary color palette.

18. The one or more computer readable storage media of claim 17 wherein each one of the set of primary color controls corresponds to a different one of a set of color hues.

19. The one or more computer readable storage media of claim 18 wherein each one of the set of secondary color controls corresponds to a shade of a color hue in the set of colors that corresponds to the primary color control in the center position in the primary color palette.

20. The one or more computer readable storage media of claim 17 wherein the color palette comprises a semi-circle shape, wherein the color palette further comprises the set of primary controls arranged in an outer semi-circle within the semi-circle shape, and wherein the color palette further comprises the set of secondary controls arranged in an inner semi-circle within the semi-circle shape.
